(19) United States
(12) Patent Application Publication
(10) Pub. No.: US 2006/0258278 A1
(43) Pub. Date: Nov. 16, 2006

(54) Coin-dispensing apparatus

(75) Inventor: Chih-Nan Chen, Kaohsiung City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SHANG YANG INDUSTRIAL CO., LTD.

(21) Appl. No.: 11/433,856

(22) Filed: May 15, 2006

(30) Foreign Application Priority Data
May 16, 2005 (TW) 094207874

(51) Int. Cl. G07D 1/00

(52) U.S. Cl. 453/57

(57) ABSTRACT

A coin-dispensing apparatus includes a coin-dispensing unit having a housing, a drive module, a rotary plate, a coin holder, and a coin-ejecting unit. The housing has coin stops and a coin exit slot. The drive module has a drive shaft that is formed with first meshing elements. The rotary plate is formed with coin holes, ribs, and a shaft hole having second meshing elements meshing with the first meshing elements. The coin holder surrounds the rotary plate and is formed with a gap When the rotary plate is rotated, one of the coin holes is aligned with the coin exit slot, and the ribs cooperate with the coin stops to stop a coin in the coin hole and move the coin out of the same and through the gap. The coin-ejecting unit then ejects the coin through the coin exit slot.

### CROSS-REFERENCE TO RELATED APPLICATION

This application claims priority of Taiwanese Application No. 094207874, filed on May 16, 2005.

### BACKGROUND OF THE INVENTION

1. Field of the Invention

The present invention relates to a coin-dispensing apparatus including at least one coin-dispensing unit, in which a rotary plate is engaged with a drive shaft in such a manner that,wear between these elements is minimized.

2. Description of the Related Art

As shown in FIG. 1, a conventional coin dispenser 1 includes a housing 11, a drive unit 12 mounted in the housing 11, a rotary plate 13 driven by the drive unit 12 to rotate on the housing 11, a coin holder 14 disposed on the housing 11 and surrounding the rotary plate 13, and a coin-ejecting unit 15 rotatably mounted in the housing 11 and functioning to eject coins.

The housing 11 includes a support wall 111, and a coin output opening 112 formed in the support wall 111.

The drive unit 12 includes a drive shaft 121 that is extended through the support wall 111 and driven to rotate. The drive shaft 121 has a semi-circular cross section to thereby be formed with a flat portion 122.

The rotary plate 13 is formed with a shaft hole 132 that is fittingly engaged with the drive shaft 121 of the drive unit 12. The rotary plate 13 is further formed with angularly spaced-apart coin holes 133 about the shaft hole 132 for respectively receiving coins (not shown). Through the engagement between the shaft hole 132 and the drive shaft 121, the rotary plate 13 is driven to rotate by the drive shaft 121.

The coin holder 14 is made of a plastic material, and is formed with a gap 141 adjacent to the support wall 111 and proximate to the coin-ejecting unit 15.

The coin-ejecting unit 15 is operable to rotate and has a plurality of arms 151. By rotation of the coin-ejecting unit 15, the arms 151 pass into and out of the gap 141 in the coin holder 14 to thereby remove the coins in aligned ones of the coin holes 133 in the rotary plate 13. Continued rotation of the coin-ejecting unit 15 results in dispensing of the coins through the coin output opening 112 in the housing 11.

As a result of the shape of the drive shaft 121, only the flat portion 122 thereof is used to transfer the torque of the drive unit 12 to the rotary plate 13. That is, only a minimal drive contact area is realized between the drive shaft 121 of the drive unit 12 and the shaft hole 132 in the rotary plate 13. As a result, the drive shaft 121 and the shaft hole 132 may wear over time, a situation that may be accelerated by vibrations generated by the churning of the coins in the coin holder 14 during operation of the coin dispenser 1. If the wear becomes severe, a gap may be formed between the drive shaft 121 and the rotary plate 13 such that the latter rocks during rotation, which further accelerates wear. The situation may deteriorate to the point where coin dispensing is no longer possible.

In addition, since the coin holder 14 is made of a plastic material, bumping and rubbing of the coins with the coin holder 14 may result in damage to the coin holder 14.

### SUMMARY OF THE INVENTION

Therefore, the object of this invention is to provide a coin-dispensing apparatus including at least one coin-dispensing unit having a rotary plate that is engaged with a drive shaft of a drive module in such a manner that wear between these elements is minimized.

According to this invention, a coin-dispensing apparatus adapted for dispensing coins comprises at least one coin-dispensing unit. The coin-dispensing unit includes a housing having an inclined support wall with an outer surface, a plurality of spaced-apart coin stops disposed on the outer surface of the support wall, and a coin exit slot formed in the support wall at a position above the coin stops; a drive module disposed in the housing, and having a drive shaft extending through the support wall of the housing and driven rotatably by the drive module, the drive shaft having an outer peripheral surface, and a plurality of first meshing elements formed on the outer peripheral surface of the drive shaft; a rotary plate having a bottom surface and being formed with a shaft hole therethrough, the shaft hole being defined by a shaft hole wall, the rotary plate being further formed with a plurality of angularly spaced apart coin holes about the shaft hole and adapted for respectively receiving coins, a plurality of second meshing elements formed on the shaft hole wall and meshing with the first meshing elements of the drive shaft so that the rotary plate is coupled to and is driven to rotate by the drive shaft, and a plurality of ribs disposed on the bottom surface of the rotary plate, at least one of the ribs being interposed between each adjacent pair of the coin holes; a coin holder disposed on the support wall of the housing so as to surround the rotary plate and adapted for holding coins in preparation for reception by the coin holes in the rotary plate, the coin holder being formed with a gap adjacent to the support wall and proximate to the coin exit slot; and a resilient coin-ejecting unit disposed on the support wall of the housing between the coin exit slot and the gap of the coin holder.

When the rotary plate is rotated to a position for aligning one of the coin holes with the coin exit slot, the ribs of the rotary plate cooperate with the coin stops of the housing to stop the coin in the aligned one of the coin holes in the rotary plate and move the coin out of the aligned one of the coin holes and through the gap in the coin holder upon further rotation of the rotary plate. The coin-ejecting unit resiliently ejects the coin out through the coin exit slot when the coin is moved out of the gap.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional coin dispenser;

FIG. 2 is an exploded perspective view of a coin-dispensing unit of a coin-dispensing apparatus according to a first preferred embodiment of the present invention;

FIG. 3 is a sectional side view of the coin-dispensing unit of FIG. 2;

FIG. 4 is a fragmentary exploded perspective view, illustrating a rotary plate and a drive shaft of the coin-dispensing unit of FIG. 2;

FIG. 5 is a view similar to FIG. 4, illustrating an alternative configuration of the rotary plate and the drive shaft;

FIG. 6 is a view similar to FIG. 4, illustrating yet another alternative configuration of the rotary plate and the drive shaft;

FIGS. 7 to 9 are schematic top views of the coin-dispensing unit of FIG. 2, illustrating operation of the coin-dispensing unit as a coin is prepared for ejection from the coin-dispensing unit;

FIG. 10 is a fragmentary partly exploded perspective view of a coin-dispensing apparatus according to a second preferred embodiment of the present invention;

FIG. 11 is a perspective view of a coin-dispensing apparatus according to a third preferred embodiment of the present invention;

FIG. 12 is a fragmentary partly exploded perspective view of a coin-dispensing apparatus according to a fourth preferred embodiment of the present invention; and

FIG. 13 is an assembled top view of the coin-dispensing apparatus of FIG. 12.

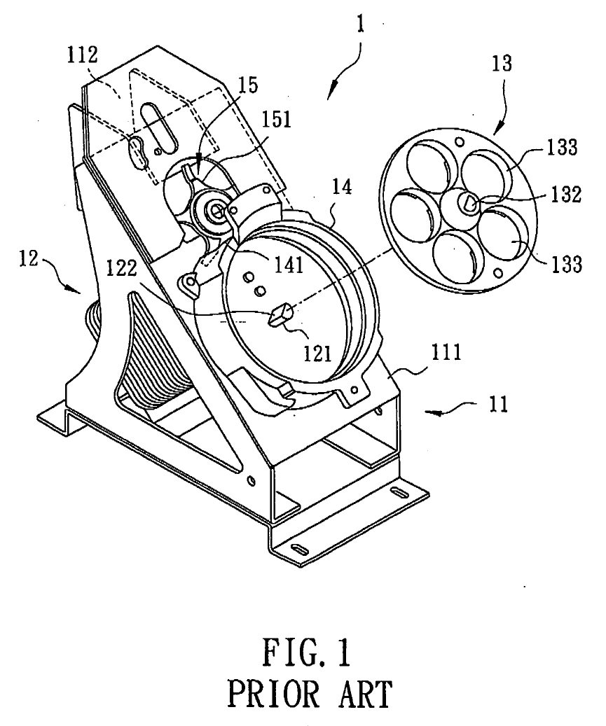

### DETAILED DESCRIPTION OF THE PREFERRED EMBODIMENTS

Before the present invention is described in greater detail, it should be noted that like elements are denoted by the same reference numerals throughout the disclosure.

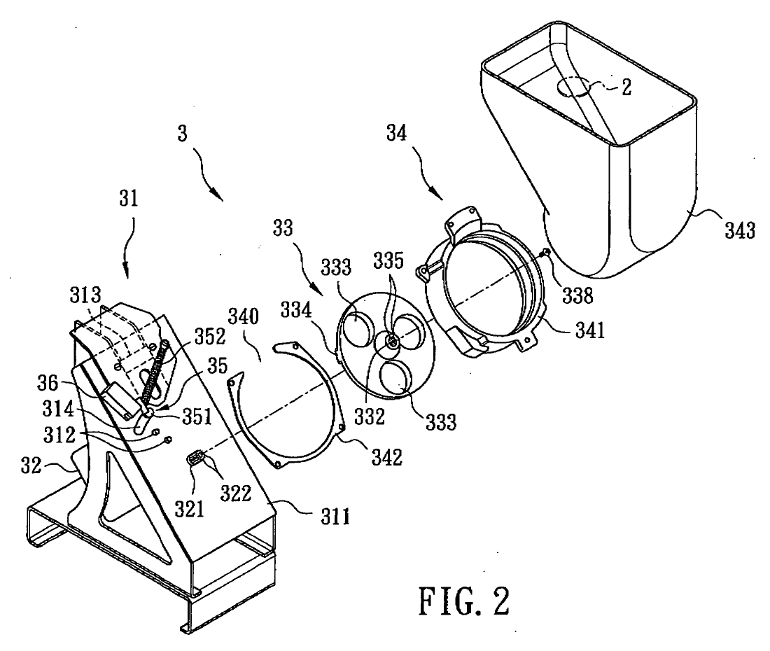

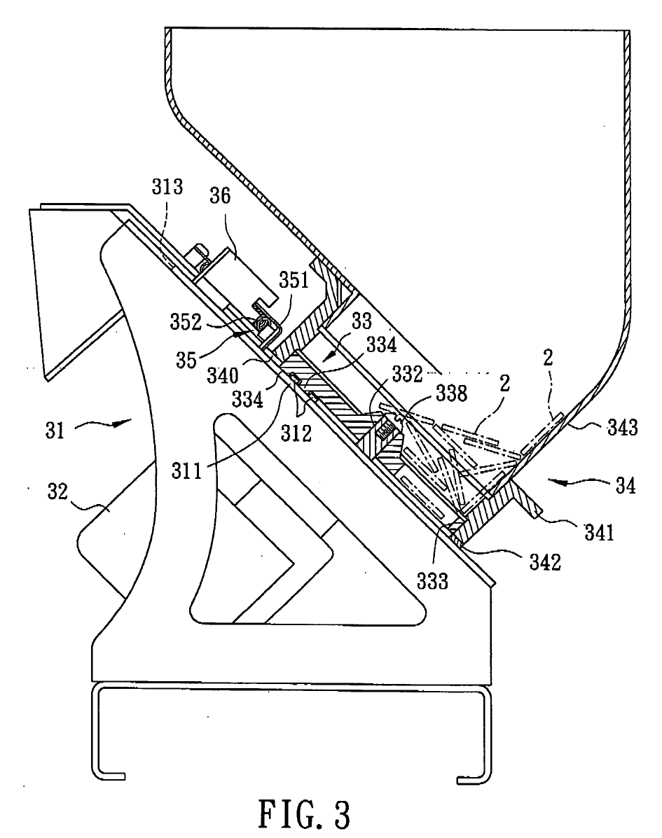

Referring to FIGS. 2 to 4, a coin-dispensing apparatus according to a first preferred embodiment of the present invention includes a single coin-dispensing unit 3 having a housing 31, a drive module 32, a rotary plate 33, a coin holder 34, a resilient coin-ejecting unit 35, and a counter 36.

The housing 31 has an inclined support wall 311 with an outer surface. A plurality of spaced-apart coin stops 312 are disposed on the outer surface of the support wall 311, and a coin exit slot 313 is formed in the support wall 311 at a position above the coin stops 312. The support wall 311 of the housing 31 is further formed with a slide slot 314 having an upper end and a lower end.

The drive module 32 is disposed in the housing 31, and includes a drive shaft 321 extending through the support wall 311 of the housing 31 and driven rotatably by the drive module 32. The drive shaft 321 has an outer peripheral surface, and a plurality of first meshing elements 322 formed on the outer peripheral surface of the drive shaft 321.

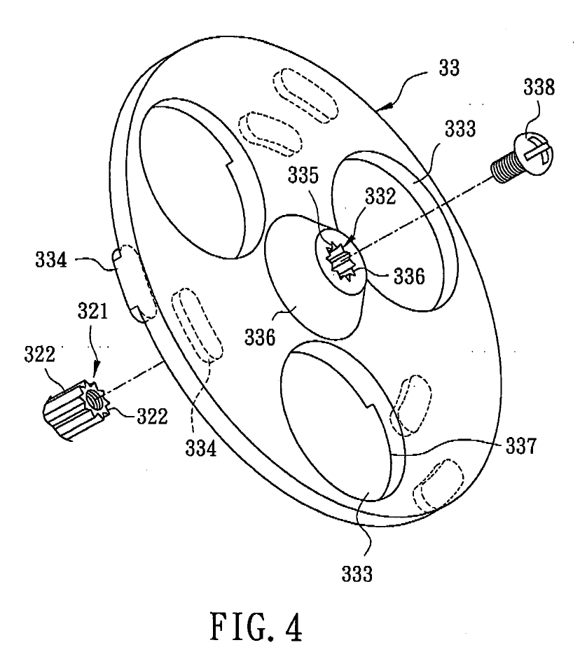

The rotary plate 33 has a bottom surface and is formed with a shaft hole 332 therethrough. The shaft hole 332 is defined by a shaft hole wall 336. The rotary plate 33 is further formed with a plurality of angularly spaced-apart coin holes 333 about the shaft hole 332. The coin holes 333 are adapted for respectively receiving coins 2. The bottom surface of the rotary plate 33 may be formed with a plurality of coin passages 337 (see FIG. 4), each of which is in spatial communication with a respective one of the coin holes 333, extends toward an adjacent one of the coin holes 333 and toward an outer periphery of the rotary plate 33, and permits removal of the coin 2 in the respective one of the coin holes 333 therethrough. A plurality of second meshing elements 335 are formed on the shaft hole wall 336, and are meshed with the first meshing elements 322 of the drive shaft 321 so that the rotary plate 33 is coupled to and is driven to rotate by the drive shaft 321. A fastener 338 may be used to further secure the rotary plate 33 to the drive shaft 321. A plurality of ribs 334 are disposed on the bottom surface of the rotary plate 33. In this embodiment, a pair of the ribs 334 is interposed between each adjacent pair of the coin holes 333.

Each of the first meshing elements 322 of the drive shaft 321 is formed as a tooth having a sharp peak portion, and the second meshing elements 335 of the rotary plate 33 fittingly engage the first meshing elements 322 of the drive shaft 321.

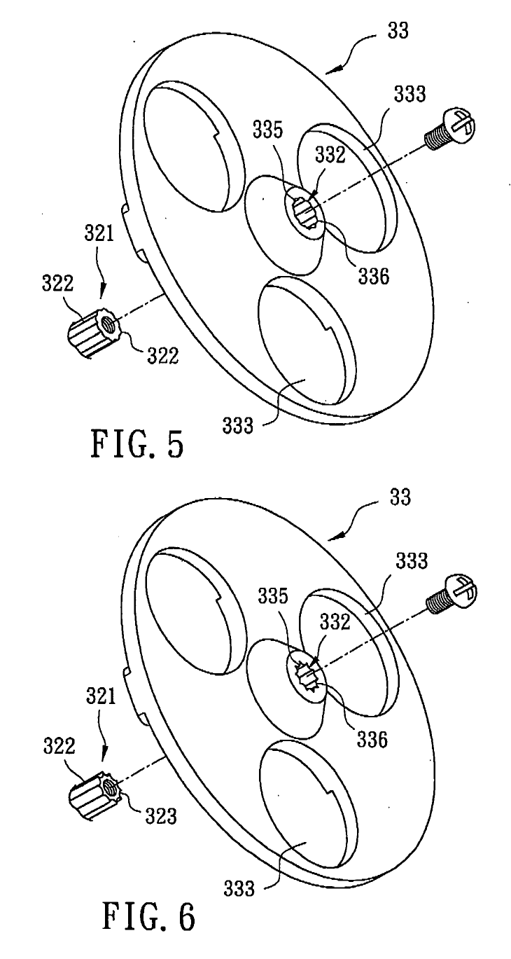

In an alternative configuration, with reference to FIG. 5, each of the first meshing elements 322 of the drive shaft 321 is formed as a tooth having a rounded peak portion, and the second meshing elements 335 of the rotary plate 33 fittingly engage the first meshing elements 322 of the drive shaft 321.

In yet another alternative configuration, with reference to FIG. 6, each of the first meshing elements 322 of the drive shaft 321 is formed as a tooth having a sharp peak portion, and the drive shaft 321 further includes rounded valley portions 323 formed on the outer peripheral surface thereof respectively between each adjacent pair of the first meshing elements 322. The second meshing elements 335 of the rotary plate 33 fittingly engage the first meshing elements 322 and the valley portions 323 of the drive shaft 321.

Referring back to FIGS. 2 to 4, the coin holder 34 is disposed on the support wall 311 of the housing 31 so as to surround the rotary plate 33. The coin holder 34 is adapted for holding coins 2 in preparation for reception by the coin holes 333 in the rotary plate 33. The coin holder 34 is formed with a gap 340 adjacent to the support wall 311 and proximate to the coin exit slot 313. In this embodiment, the coin holder 34 includes an annular member 341 surrounding the rotary plate 33, a U-shaped gasket 342 having a break and interposed between the support wall 311 of the housing 31 and the annular member 341, and a coin storage container 343 disposed fixedly on and in spatial communication with the annular member 341 and adapted to provide additional space for holding coins 2. With this configuration, the gap 340 is defined by the annular member 341, the break in the gasket 342, and the support wall 311. However, the gap 340 may be directly formed in the annular member 341, in which case the gasket 342 need not be included in the configuration of the coin holder 34. In this embodiment, the annular member 341 and the coin storage container 343 are made of a metal material.

The resilient coin-ejecting unit 35 is disposed on the support wall 311 of the housing 31 between the coin exit slot 313 and the gap 340 in the coin holder 34. The coin-ejecting unit 35 includes a lever 351 slidably disposed in the slide slot 314 in the housing 31 proximate to the gap 340 in the coin holder 34, and a resilient member 352 coupled to the lever 351 and providing a biasing force to the lever 351 toward the upper end of the slide slot 314. As an example, the resilient member 352 may be a coiled tension spring, in which case one end of the resilient member 352 is coupled to the support wall 311 and its other end is coupled to the lever 351.

The counter 36 is disposed on the support wall 311 of the housing 31, and is operable to detect and count movement of the lever 351 of the coin-ejecting unit 35 indicative of completion of a coin-ejecting operation.

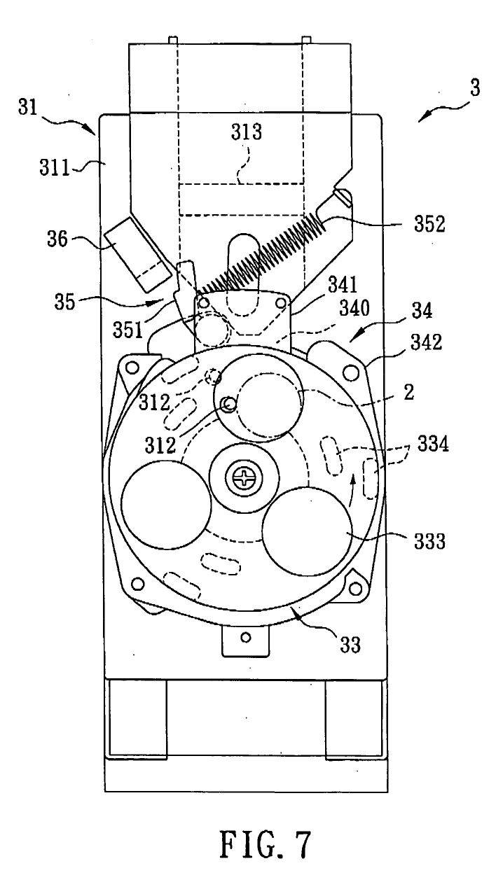

Operation of the coin-dispensing unit 3 of the coin-dispensing apparatus according to the first preferred embodiment will now be described with reference to FIGS. 7 to 9.

Referring first to FIG. 7, when the rotary plate 33 is rotated to a position for aligning one of the coin holes 333 holding a coin 2 with the coin exit slot 313, the coin 2 abuts against the coin stops 312 of the housing 31 and is prevented from moving further with the coin hole 333. Additional rotation of the rotary plate 33 results in removal of the coin 2 from the coin hole 333 via the respective one of the coin passages 337 (see FIG. 4).

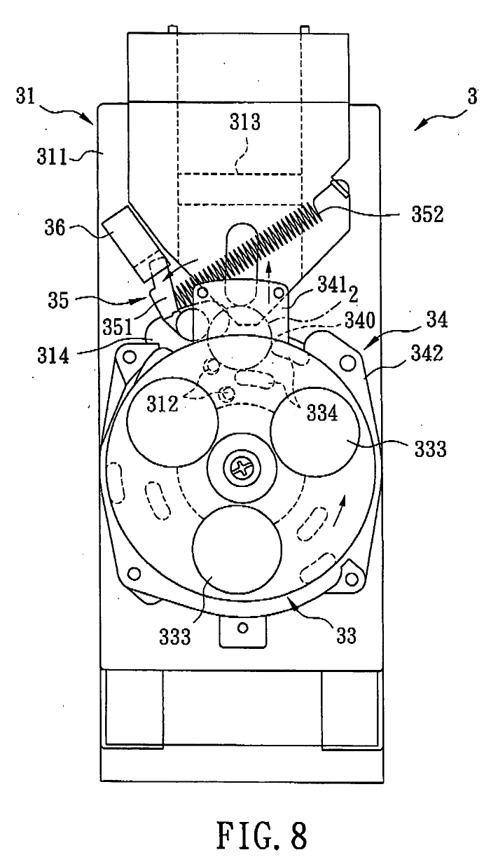

Referring to FIG. 8, with the continued rotation of the rotary plate 33, a corresponding pair of the ribs 334 comes into contact with the coin 2. The ribs 334 and the coin stops 312 then cooperate to move the coin 2 out through the gap 340 in the coin holder 340. While the coin 2 is being moved out through the gap 340, the coin 2 pushes on the lever 351 of the coin-ejecting unit 35 to move the lever 351 along the slide slot 314 in the housing 31 toward the lower end of the slide slot 314. As a result, the resilient member 352 is stretched to thereby store a biasing force.

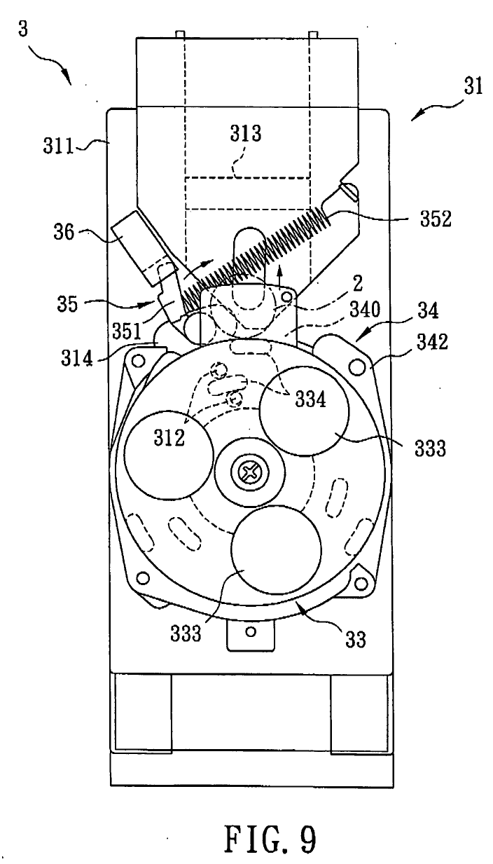

Subsequently, with reference to FIG. 9, with the continued rotation of the rotary plate 33, the two ribs 334 cooperate now with the lever 351 to push the coin 2 completely out through the gap 340. When this occurs, the resilient member 352 biases the lever 351 to move along the slide slot 314 back toward the upper end thereof (i.e., back to its original start position) so as to resiliently eject the coin 2 out through the coin exit slot 313.

During the above operation, the counter 36 may detect movement of the lever 351 of the coin-ejecting unit 35. For example, the counter 36 may utilize conventional motion sensor technology such that movement of the lever 351 along the slide slot 314 in preparation for ejecting the coin 2 as shown in FIG. 8 interrupts a light beam of the motion sensor. In this case, the counter 36 utilizes the interruption of the light beam to detect and count movement of the coin-ejecting unit 35 indicative of completion of a coin-ejecting operation.

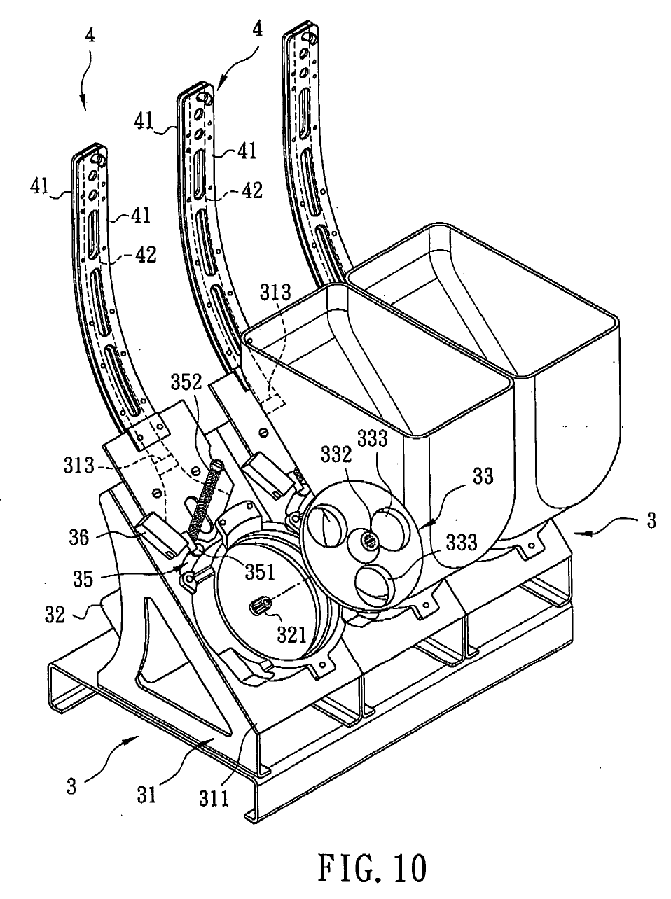

Referring to FIG. 10, the coin-dispensing apparatus according to a second preferred embodiment of the present invention includes a plurality of the coin-dispensing units 3 that may be arranged in a row in a spaced-apart or side-by-side configuration. By using a plurality of the coin-dispensing units 3 in this embodiment (or in any of the other embodiments for that matter), coins (not shown) of different denominations may be dispensed from the coin-dispensing apparatus. Each of the coin-dispensing units 3 further includes a coin guide 4 mounted to an upper end of the support wall 311 of the housing 31. The coin guide 4 includes a pair of spaced-apart plates 41 that are gradually curved upward and that define a path 42 therebetween in spatial communication with the coin exit slot 313 such that the coin ejected through the coin exit slot 313 can travel through the path 42 for dispensing from the coin-dispensing unit 3.

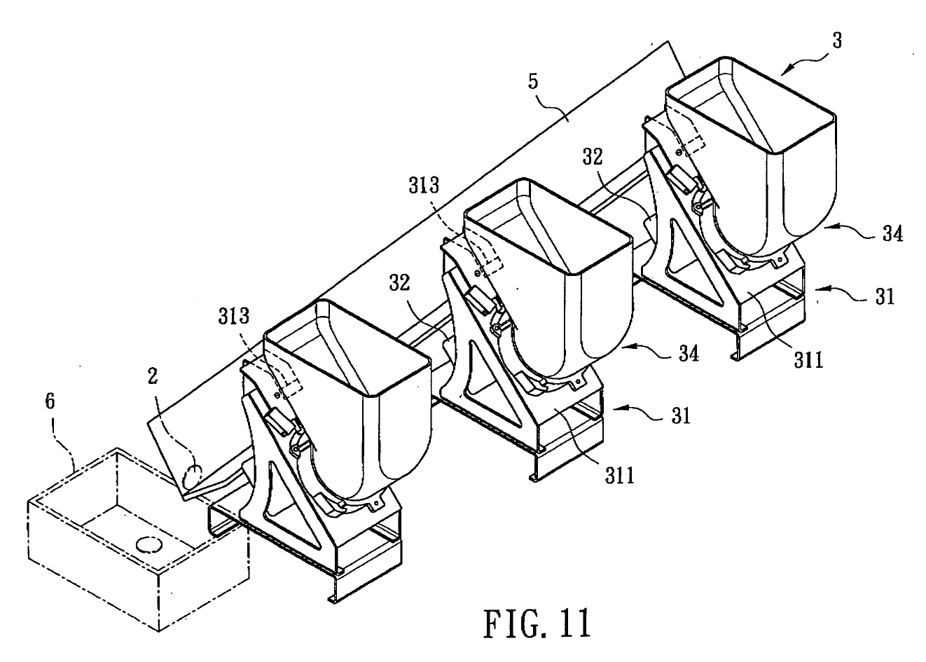

Referring to FIG. 11, the coin-dispensing apparatus according to a third preferred embodiment of the present invention includes a plurality of the coin-dispensing units 3 that may be arranged in a row in a spaced-apart or side-by-side configuration. The coin-dispensing apparatus further includes a coin collector 5 adapted to receive the coins 2 ejected through the coin exit slots 313 and to direct the coins 2 to a predetermined location. The coin collector 5 extends along a length of the row of the coin-dispensing units 3. In this embodiment, the coin collector 5 has a V-shaped cross section and is positioned under the coin exit slots 313 of the housings 31. A receptacle 6 may be positioned at one end of the coin collector 5 to receive the coins 2 exiting the coin collector 5.

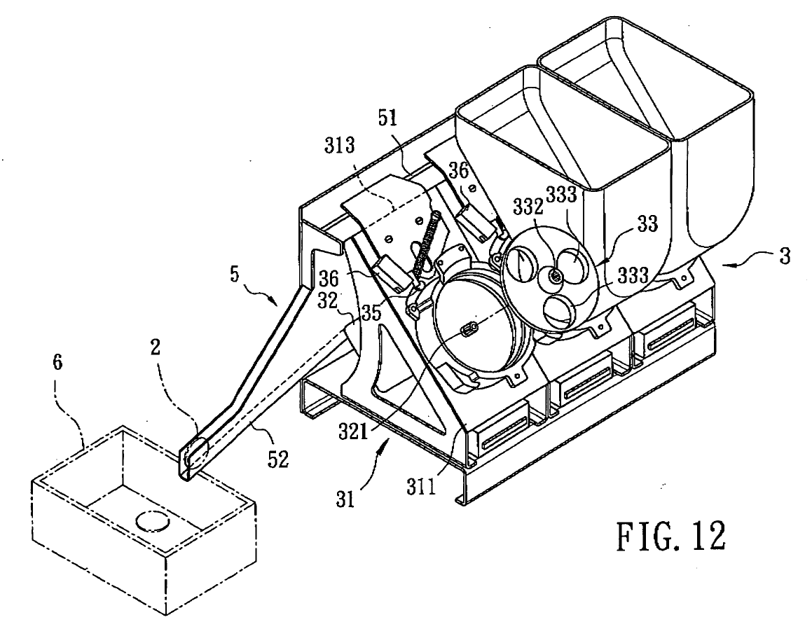

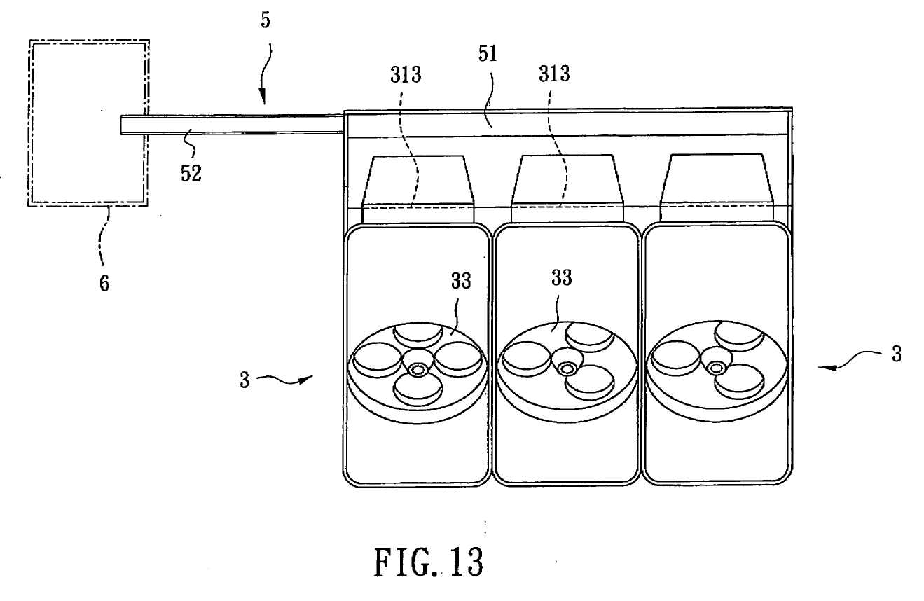

Referring to FIGS. 12 and 13, the coin-dispensing apparatus according to a fourth preferred embodiment of the present invention includes a plurality of the coin-dispensing units 3 that may be arranged in a row in a spaced-apart or side-by-side configuration. As in the third embodiment, the coin-dispensing apparatus further includes a coin collector 5 adapted to receive the coins 2 ejected through the coin exit slots 313 and to direct the coins 2 to a predetermined location. The coin collector 5 extends along a length of the row of the coin-dispensing units 3. In this embodiment, the coin collector 5 includes a guide plate 51 positioned below the coin exit slots 313 of the housings 31, and a collecting groove plate 52 connected to one end of the guide plate 51 and having a U-shaped cross section. A receptacle 6 may be positioned at one end of the coin collector 5 to receive the coins 2 exiting the coin collector 5.

In the coin-dispensing apparatus of the present invention as described above, the structures of the first and second meshing elements 322, 332 (and of the rounded valley portions 323 of FIG. 6) for each of the coin-dispensing units 3 result in a larger drive contact area between the drive shaft 321 of the drive module 32 and the shaft hole 332 of the rotary plate 33 compared to the conventional coin dispenser described hereinabove. Hence, wear of the drive shaft 321 and the shaft hole 332 may be significantly reduced.

In addition, by forming the annular member 341 and the coin storage container 343 of a metal material, damage to these elements through contact with the coins 2 is minimized.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A coin-dispensing apparatus adapted for dispensing coins, comprising:
at least one coin-dispensing unit including
a housing having an inclined support wall with an outer surface, a plurality of spaced-apart coin stops disposed on said outer surface of said support wall, and a coin exit slot formed in said support wall at a position above said coin stops,
a driver module disposed in said housing, and having a drive shaft extending through said support wall of said housing and driven rotatably by said drive module, said drive shaft having an outer peripheral surface, and a plurality of first meshing elements formed on said outer peripheral surface of said drive shaft,
a rotary plate having a bottom surface and being formed with a shaft hole therethrough, said shaft hole being defined by a shaft hole wall, said rotary plate being further formed with a plurality of angularly spaced apart coin holes about said shaft hole and adapted for respectively receiving coins, a plurality of second meshing elements formed on said shaft hole wall and meshing with said first meshing elements of said drive shaft so that said rotary plate is coupled to and is driven to rotate by said drive shaft, and a plurality of ribs disposed on said bottom surface of said rotary plate, at least one of said ribs being interposed between each adjacent pair of said coin holes,
a coin holder disposed on said support wall of said housing so as to surround said rotary plate and adapted for holding coins in preparation for reception by said coin holes in said rotary plate, said coin holder being formed with a gap adjacent to said support wall and proximate to said coin exit slot, and
a resilient coin-ejecting unit disposed on said support wall of said housing between said coin exit slot and said gap of said coin holder;
wherein when said rotary plate is rotated to a position for aligning one of said coin holes with said coin exit slot, said ribs of said rotary plate cooperate with said coin stops of said housing to stop the coin in the aligned one of said coin holes in said rotary plate and move the coin out of the aligned one of said coin holes and through said gap in said coin holder upon further rotation of said rotary plate, said coin-ejecting unit resiliently ejecting the coin out through said coin exit slot when the coin is moved out of said gap.

2. The coin-dispensing apparatus of claim 1, wherein said coin holder of said coin-dispensing unit includes an annular member surrounding said rotary plate, a U-shaped gasket having a break and interposed between said support wall of said housing and said annular member, and a coin storage container disposed fixedly on and in spatial communication with said annular member and adapted to provide additional space for holding coins in preparation for reception by said coin holes in said rotary plate, said gap being defined by said annular member, said break in said gasket, and said support wall.

3. The coin-dispensing apparatus of claim 2, wherein said annular member of said coin holder is made of a metal material.

4. The coin-dispensing apparatus of claim 1, wherein said support wall of said housing is formed with a slide slot having an upper end and a lower end, said coin-ejecting unit including a lever slidably disposed in said slide slot proximate to said gap in said coin holder, and a resilient member coupled to said lever and providing a biasing force to said lever toward said upper end of said slide slot, said lever being displaced along said slide slot toward said lower end thereof through contact with the coin when the coin is being moved out through said gap in said coin holder, said resilient member biasing said lever to move along said slide slot back toward said upper end thereof after the coin is moved out of said gap so as to eject the coin out through said coin exit slot.

5. The coin-dispensing apparatus of claim 1, wherein said coin-dispensing unit further includes a counter disposed on said support wall of said housing, said counter being operable to detect and count movement of said coin-ejecting unit indicative of completion of a coin-ejecting operation.

6. The coin-dispensing apparatus of claim 1, wherein said coin-dispensing unit further includes a coin guide mounted to an upper end of said support wall of said housing, said coin guide including a pair of spaced-apart plates that are gradually curved upward and that define a path therebetween in spatial communication with said coin exit slot such that the coin ejected through said coin exit slot can travel through said path for dispensing from said coin-dispensing unit.

7. The coin-dispensing apparatus of claim 6, wherein a plurality of said coin-dispensing units are arranged in a row in one of a spaced-apart and side-by-side configuration.

8. The coin-dispensing apparatus of claim 1, further comprising a coin collector adapted to receive the coin ejected through said coin exit slot and to direct the coin to a predetermined location.

9. The coin-dispensing apparatus of claim 8, wherein said coin collector has a V-shaped cross section and is positioned under said coin exit slot of said housing.

10. The coin-dispensing apparatus of claim 8, wherein a plurality of said coin-dispensing units are arranged in a row in one of a spaced-apart and side-by-side configuration, said coin collector extending along a length of the row of said coin-dispensing units so as to receive and collect the coins ejected through said coin exit slots of said coin-dispensing units.

11. The coin-dispensing apparatus of claim 8, wherein said coin collector includes a guide plate positioned below said coin exit slot of said housing, and a collecting groove plate connected to one end of said guide plate and having a U-shaped cross section.

12. The coin-dispensing apparatus of claim 11, wherein a plurality of said coin-dispensing units are arranged in a row in one of a spaced-apart and side-by-side configuration, said coin collector extending along a length of the row of said coin-dispensing units, and being adapted to receive and collect the coins ejected through said coin exit slots of said coin-dispensing units.

13. The coin-dispensing apparatus of claim 1, wherein each of said first meshing elements of said drive shaft is formed as a tooth having a sharp peak portion, said second meshing elements of said rotary plate fittingly engaging said first meshing elements of said drive shaft.

14. The coin-dispensing apparatus of claim 1, wherein each of said first meshing elements of said drive shaft is formed as a tooth having a rounded peak portion, said second meshing elements of said rotary plate fittingly engaging said first meshing elements of said drive shaft.

15. The coin-dispensing apparatus of claim 1, wherein each of said first meshing elements of said drive shaft is formed as a tooth having a sharp peak portion, said drive shaft further having rounded valley portions formed on said outer peripheral surface thereof respectively between each adjacent pair of said first meshing elements, said second meshing elements of said rotary plate fittingly engaging said first meshing elements and said valley portions of said drive shaft.
